(19) United States
(12) Patent Application Publication
(10) Pub. No.: US 2013/0136594 A1
(43) Pub. Date: May 30, 2013

(54) WIND TURBINE AND CONTROL METHOD FOR CONTROLLING THE SAME

(71) Applicants: Matteo Casazza, Val Di Vizze (IT); Amedeo Sabbadin, Padova (IT); Gunther Stockner, Velturno (IT)

(72) Inventors: Matteo Casazza, Val Di Vizze (IT); Amedeo Sabbadin, Padova (IT); Gunther Stockner, Velturno (IT)

(73) Assignee: WILIC S.AR.L., Luxembourg (LU)

(21) Appl. No.: 13/485,157

(22) Filed: May 31, 2012

(30) Foreign Application Priority Data
Jun. 3, 2011 (EP) EP11168738.0

(51) Int. Cl. F03D 11/00

(52) U.S. Cl. CPC F03D 11/0041
USPC 416/1; 416/5

(57) ABSTRACT

A wind turbine is provided with a rotor rotatable about a rotor axis and having a plurality of blades rotatably fitted to a hub about a blade axis and a plurality of pitch actuators configured to adjust the pitch angles of the blades; a brake controlled by a brake actuator configured to arrest the rotor; a rotating electric machine connected to the rotor; an inverter configured to control the rotating electric machine; and a control system including a plurality of image reflection measuring devices configured to detect the deformations of each blade and configured to emit control signals configured to selectively control at least one of pitch actuators; the brake actuator; and the inverter as a function of the deformations retrieved.

### PRIORITY CLAIM

This application claims the benefit of and priority to European Patent Application No. 11168738.0, filed on Jun. 3, 2011, the entire contents of which is incorporated by reference herein.

### BACKGROUND

Generally, known wind turbine comprise a vertical support structure; a nacelle atop the support structure; a rotor rotatably fitted to the nacelle and including a hub, a plurality of blades rotatably fitted to the hub and a plurality of pitch actuators for adjusting the pitch angles of the blades. Such wind turbines are normally controlled according to a control strategy based on one or more measured control parameters, such as wind speed or wind direction. Accordingly, a control system used for controlling operation of these known wind turbines is normally connected to one or more sensors, each sensor being arranged to measure a specific surrounding condition, such as the wind speed. However, the measurements of the physical parameter, such as the wind speed, are often disturbed by the wind turbine and are only reliable to a given extent. For example, a wind speed sensor is normally placed on the nacelle and is disturbed by the rotor and not able to detect the differences along the area swept by the rotor.

The often poor reliability of the information retrieved through the conventional sensors prejudice a fine control of the wind turbine.

### SUMMARY

The present disclosure relates to a wind turbine. In particular, the present disclosure relates to a wind turbine including a control system configured to control the wind turbine, and to a method for controlling the wind turbine.

It is an advantage of the present disclosure to provide a wind turbine that can be relatively easily and finely controlled.

According to one embodiment of the present disclosure, a wind turbine comprises a rotor rotatable about a rotor axis and having a plurality of blades rotatably fitted to a hub about a blade axis and a plurality of pitch actuators configured to adjust the pitch angles of the blades; a brake controlled by a brake actuator configured to arrest the rotor; a rotating electric machine connected to the rotor; an inverter configured to control the rotating electric machine; and a control system, which comprises a plurality of image reflection measuring devices configured to detect the deformations of each blade, and emit control signals for selectively controlling at least one of the pitch actuators; the brake actuator; and the inverter as a function of deformations retrieved by the plurality of image reflection measuring devices.

The reliable information retrieved by the image reflection measuring devices associated to all blades of the rotor allows retrieving several operational parameters regarding the rotor. In certain embodiments, this information is extremely valuable to finely control the wind turbine.

According to one embodiment of the present disclosure, each image reflection measuring device is located inside a blade and comprises a light source, at least two light reflectors spaced apart along the blade for reflecting the light, and a camera for detecting the images.

This arrangement allows retrieving, for each blade, relevant information regarding at least two portions of each blade. In one embodiment, the light reflectors are spaced apart along the blade axes and located at designated or given distances from the rotor axes; the light reflectors are distributed with the same spacing and the same distances from the rotor axis in each blade.

Accordingly the static and dynamic deformations of each blade can be significantly compared to the static and dynamic deformations of the other blades.

In accordance with one embodiment of the present disclosure, each blade comprises a root portion, an intermediate portion, and a tip portion having a structure configured to favour the twist of the tip portion with respect to the intermediate portion when the tip portion is loaded transversely to the blade axis; the blade being provided with at least one light reflector in the intermediate portion and at least one light reflector in the tip portion.

The tip portions of each blade may automatically twist when the load applied to the tip portion exceeds a designated or given value. The light reflector in the tip portion can retrieve the occurrence of this event and the extent of the twist with respect to the intermediate portion and to the root portion so as to permit evaluating further adjustment of the pitch angle of the blade.

According to a further embodiment, each blade of the rotor is provided with at least one actuated aerodynamic surface, such as a flap pivotally connected to the structure of the blade and extending along the trailing edge of the tip portion.

The adjustment of the actuated aerodynamic surface allows varying the distribution of the load along the blade. In particular, the actuated aerodynamic surface is positively actuated and is associated with a further light reflector of the image reflection measuring device so as to allow controlling the position of the actuated aerodynamic surface.

In another embodiment, the additional light reflector is mounted on the blade structure, such as the spar, in close proximity to the actuated aerodynamic surface in order to retrieve the effects produced by the actuation of the actuated aerodynamic surface.

According to one embodiment of the present disclosure, the control system comprises a plurality of image-processing units, which emit a set of position signals correlated to the positions of the light reflectors in the blades; and a signal-processing unit configured to run a plurality of programs processing the complete set of position signals (or subsets of the set of position signals) and emitting said control signals.

In particular, the control system is configured to acquire further signals such as a speed signal correlated to the rotational speed of the rotor; said programs including a rotor imbalance detecting program configured to detect the misalignment of the rotor axis with respect to a nominal position of the rotor axis on the bases of oscillation signals derived from the set of position signals and the speed signal.

According to another aspect of the disclosure, there is provided a control method for controlling operation of a wind turbine.

According to one embodiment of the present disclosure, there is provided a control method for controlling the operational parameter of the wind turbine, wherein the wind turbine comprises a rotor rotatable about a rotor axis and having a plurality of blades rotatably fitted to a hub about a blade axis and a plurality of pitch actuators configured to adjust the pitch angles of the blades; a brake controlled by a brake actuator configured to arrest the rotor; a rotating electric machine connected to the rotor; an inverter configured to control the rotating electric machine; and a control system, which comprises a plurality of image reflection measuring devices configured to detect the deformations of each blade; the method comprising the steps of retrieving the deformations of the plurality of the blades; and emitting control signals as a function of the deformations retrieved by the plurality of image reflection measuring devices; and using the control signals to selectively control at least one of the pitch actuators, the brake actuator, and the inverter.

In accordance with one embodiment of the present disclosure, the method further comprising the steps of using a plurality of image-processing units to emit a set of position signals correlated to the position of at least two light reflectors located inside each blade of the plurality of blades; and using a plurality of programs configured to calculate and emit said control signals to process the set of position signals (or subset of the set of position signals).

In one embodiment, to reduce the number of operation required, only those position signals that are significant for a designated or given operational control parameter under control are selected.

According to one embodiment of the present disclosure, the method comprises the steps of comparing the position signals correlated to the deformation of one blade to threshold values; and emitting a control signal for controlling the pitch actuator of said blade or arresting the wind turbine when one of the position signals exceeds the related threshold value.

This control of this embodiment allows preserving the integrity of the blade and is, in at least one embodiment, run for each blade of the rotor.

According to a further embodiment, the method disclosed herein comprises the steps of processing the subset of position signals of each blade through time in order to retrieve the oscillations of the blade and determine frequencies and amplitudes of each oscillation; comparing the oscillation frequencies with reference values in order to avoid critical oscillation frequencies; and emitting a control signal for controlling the pitch actuator in order to modify the oscillation frequency of the blade when the oscillation frequencies fall within a critical range.

Also this embodiment aims at preserving the blades and reducing critical stresses of the blades.

One embodiment of the present disclosure envisages processing the entire set of position signals of all blades; calculating the overall deformation of the rotor on the bases of the deviations from the neutral position values of all blades; comparing the overall deformation of the rotor and a reference threshold value; and emitting a control signal for actuating the pitch actuators of all blades when the overall deformation of the rotor exceeds this reference threshold value.

This embodiment aims at avoiding excessive stresses on the entire structure of the wind turbine such as the vertical structure, the nacelle, and the bearing.

A further embodiment of the present disclosure envisages processing the subset of position signals of at least one blade for calculating the oscillation frequencies of the blade; acquiring the energy output of the rotating electric machine; comparing the calculated oscillation frequencies at said energy output with the natural oscillation frequencies of said blade at the same energy output in absence of ice; and emitting a control signal for arresting the wind turbine and/or start a de-icing program when the differences between the calculated frequencies and the natural frequencies exceed designated or given threshold values.

Advantageously the comparison between the natural oscillation frequencies and the retrieved frequencies at the same operational conditions gives information regarding the presence of ice on the blade.

A further embodiment of the present disclosure comprises the steps of processing a subset of position signals in order to calculate the oscillations (amplitudes and frequencies) of at least one blade; and emitting a control signal for adjusting the inverter and or the pitch of one or more blades when the differences of oscillations (amplitudes and frequencies) though time exceeds a designated or given range and the rotor rotates at constant rotational speed.

Such a control allows detecting the rotor unbalance and correcting the rotor unbalance.

According to one embodiment of the present disclosure, the method comprises the steps of comparing the position signals associated to the two light reflectors for calculating the twist of the tip portion with respect to the intermediate portion of one blade; and emitting a control signal for controlling the pitch actuator of said blade and adjusting the pitch angle of said blade when the twist is outside a designated or given range.

The twist monitoring is relevant for the control of the blade otherwise the automatic twist determined by the load on blade would be out of control.

According to a further embodiment of the present disclosure the method comprises the step of acquiring the position of the aerodynamic actuated surface and their effects on blade load.

Additional features and advantages are described in, and will be apparent from the following Detailed Description and the figures.

### BRIEF DESCRIPTION OF THE DRAWINGS

The disclosure will now be described in further detail with reference to preferred embodiments shown in the enclosed drawings in which:

FIG. 1 is a side elevation view, with parts removed for clarity, of a wind turbine according to the present disclosure;

FIG. 2 is a side view, with parts removed for clarity, of a blade of the wind turbine of FIG. 1;

FIG. 3 is a cross-sectional view, with part removed for clarity and in an enlarged scale, of the blade of FIG. 2;

FIGS. 4 and 5 are perspectives views, with parts removed for clarity and in an enlarged scale, of two respective sections of the blade of FIG. 2;

FIG. 6 is a schematic view of a control system of the wind turbine of FIG. 1;

FIG. 7 is perspective view, with parts removed for clarity and parts in cross-section of a variation of the blade of FIG. 2; and

FIG. 8 is a cross-sectional view, with parts removed for clarity, of the blade of FIG. 7.

### DETAILED DESCRIPTION

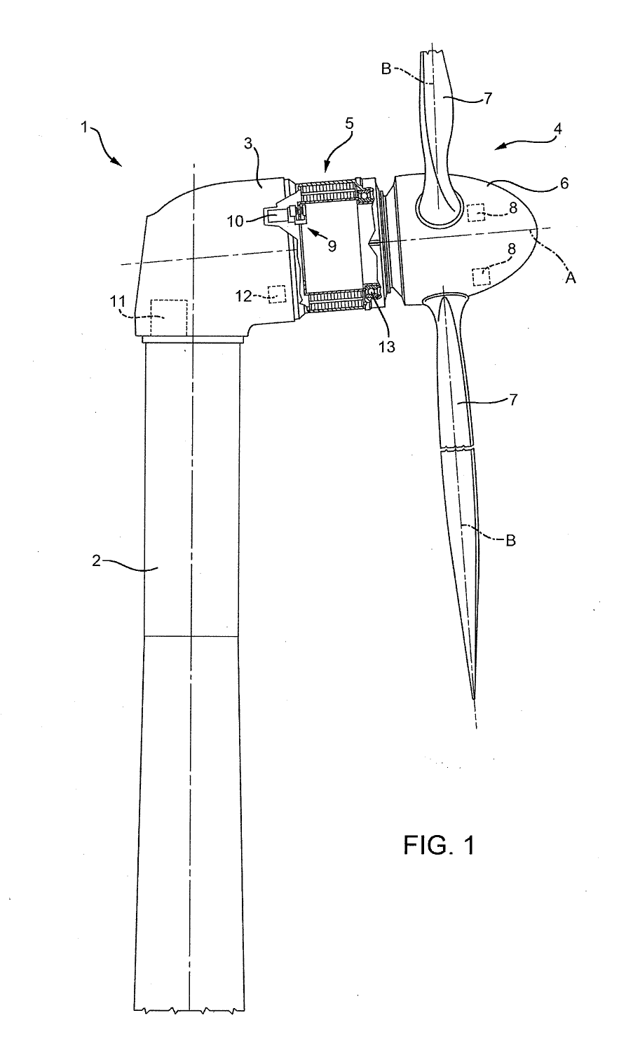

Referring now to the example embodiments of the present disclosure illustrated in FIGS. 1 to 8, with reference to FIG. 1, with numeral 1 is indicated a wind turbine, in particular for the production of electric energy. The wind turbine 1 comprises a vertical structure 2; a nacelle 3 atop the vertical structure 2; a rotor 4 rotatably fitted to the nacelle 3 about an axis A; and a rotating electrical machine 5 partly fitted to the rotor 4 and partly fitted to the nacelle 3. The rotor 4 comprises a hub 6 and a plurality of blades 7, three in the example shown, rotatably mounted to the hub 6 about axes B extending radially from axis A; and a plurality of pitch actuators 8 configured to selectively rotate each blade 7 about axis B and adjusting the pitch angles of the same. The wind turbine 1 comprises a brake 9 selectively controlled by a brake actuator 10 configured to lock the rotor 4 with respect to the nacelle 3, and an inverter 11 configured to control the rotating electric machine 5. The wind turbine 1 comprises a speed sensor 12 configured to detect the rotational speed of the rotor 4.

The wind turbine 1 of FIG. 1 is of the type having a single bearing 13 supporting the entire rotor 4, and having a rotating electrical machine 5 of tubular shape.

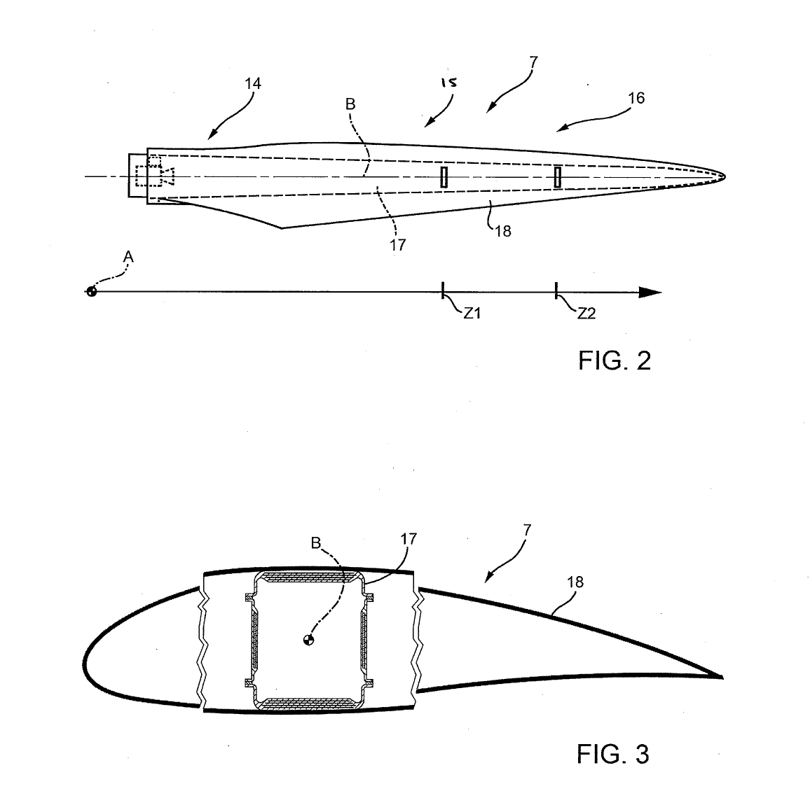

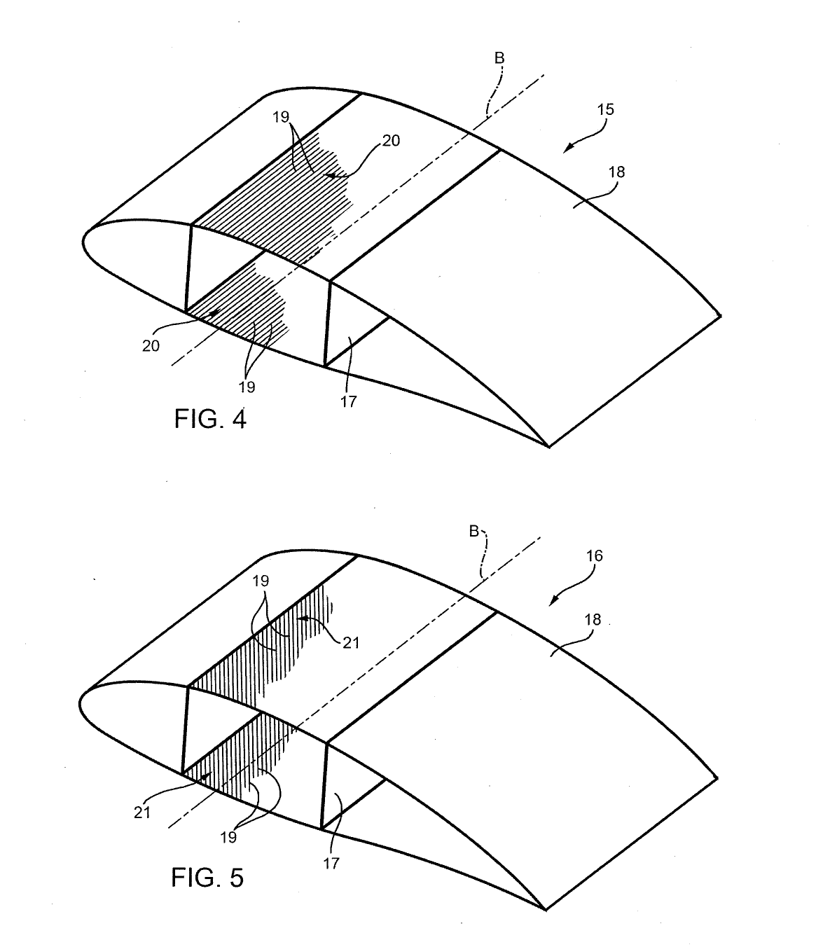

With reference to FIG. 2, each blade 7 has a root portion 14, a intermediate portion 15, and a tip portion 16; and comprises a longitudinal spar 17 extending along axis B from root portion 14 to tip portion 16, and an airfoil-shaped structure 18, which is arranged about the spar 17 and is supported by the spar 17. As better shown in FIG. 3, the spar 17 has a rectangular cross-section and confers the required stiffness to the blade 7 and transmits the load from the airfoil-shaped structure 18 to the hub 6 (as seen in FIG. 1). The spar 17 and the airfoil-shaped structure 18 are made of fibres-reinforced polymer in order to adequately withstand traction and compression stresses determined by the deformation of the blade 7 that normally occurs during the ordinary use of the wind turbine 1. The current tendency consists in increasing the length of the radius of the rotor 4 in order to increase the power transferred to the rotating electric machine 5. For this reason, a blade 7 may be even longer than 100 meters (328.08 feet). Therefore, the structure of blade 7 should be elastic and resistant. The arrangements and the numbers of fibres in the spar 15 have a relevant influences to determine the elastic deformations of the blade 7 along axis B. Usually the fibres are laid in layers in several directions so as to form a fibre matt with uniform pattern. With reference to FIG. 4, a section of blade 7 shows that the fibres 19 of the spar 17 are arranged according to pattern 20 wherein the fibres 19 are prevalently parallel to axis B, whereas in FIG. 5 the fibres 19 are arranged according to a pattern 21 wherein the fibres 19 are prevalently inclined or angled with respect to axis B. The pattern 20 of FIG. 4 offers a resistance to traction stresses that turns into a resistance to bending of blade 7 in response to a load applied perpendicularly to axis B. The pattern 21 of FIG. 5 favours the twist of the blade 7 as a reaction to a load applied perpendicularly to axis B. In use, the pattern 20 of FIG. 4 and pattern 21 of FIG. 5 allow elastic deformation of the blade 7 but cause the blade 7 to undergo different types of elastic deformations when loaded transversely to axis B.

With reference to FIG. 2, the spar 17 is provided with fibres arranged according to pattern 20 along the root portion 14 and the intermediate portion 15, and fibres arranged according to the pattern 21 along the tip portion 16. This combination of pattern 20 and 21 permits the tip portion 16 to twist with respect to intermediate portion 15 when high bending moments act on the blade 7.

This arrangement determines that the intermediate portion 15 undergoes elastic bending, whereas the tip portion 16 undergoes elastic twist deformation in addition of the deflection when the blade 7 is subject to loads perpendicular to the axis B.

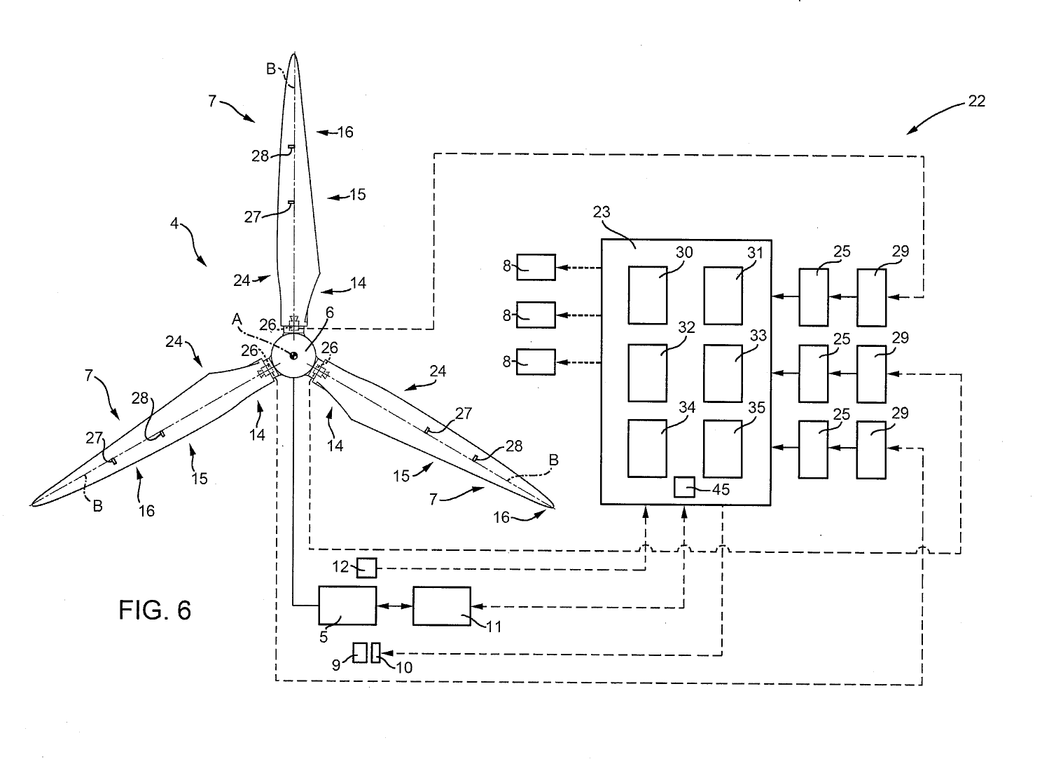

With reference to FIG. 6, the wind turbine 1 comprises a control system 22 configured to control the wind turbine 1 on the bases of a plurality of operational parameters. The control system 22 comprises a signal-processing unit 23; at least one image reflection measuring device 24 located inside each blade 7; and an image-processing unit 25 for each image reflection measuring device 24. The signal-processing unit 23 exchanges signals with the pitch actuators 8, the brake actuator 10, the inverter 11, the speed sensor 12, and the image-processing units 25.

With reference to FIG. 6, each image reflection measuring device 24 comprises a light source 26, such as a lamp configured to produce a diffused light inside the blade 7, a plurality of light reflectors 27 and 28, and one camera 29 on which the light, in particular the light reflected by light reflectors 27 and 28 impinges. The light source 26 lights the space inside the blade 7, in particular inside the spar 17. The light is prevalently reflected by the light reflectors 27 and 28 that appear to be light spots on greyish background in the image of the camera 29. The light reflected from the light reflectors impinges on a sensible area of the camera 29 which emit signals correlated to the images. The light reflectors 27 and 28 are, in at least one embodiment, located in the cavity formed by the hollow spar 17 along the axis B. Light reflector 27 is located along the intermediate portion 15 at the distance Z1 from axis A (as seen in FIG. 2), whereas light reflector 28 is located along the tip portion 16 at the distance Z2 from axis A (as seen in FIG. 2), wherein Z2 is higher than Z1. In other words, light reflectors 27 and 28 are spaced apart along axis B. It is also convenient that light reflectors 27 and 28 are radially staggered with respect to axis B.

According to one embodiment, the light reflectors 27 are located at the same distance Z1 form axis A in all blades 7 and the light reflectors 28 are located at the same distance Z2 in all blades 7 so that the deformations of each blade 7 can be significantly compared 7 with the deformations of the other blades.

With reference to FIG. 6, each image reflection measuring device 24 emits signals correlated to the retrieved images or, in other words, image-signals. Each image-processing unit 25 processes the image-signals emitted by a corresponding image reflection measuring device 24, and emits position signals correlated to the position of each light reflectors 27 and 28 in a corresponding blade 7. In other words, the image-processing unit 25 emits position signals Z1, X1(t), Y1(t) correlated to the position of the light reflector 27; and position signals Z2, X2(t), Y2(t) correlated to the position of the light reflector 28.

The image-processing units 25 emit an overall set of position signals to be processed by the signal-processing unit 23 in order to retrieve information regarding the operational parameters of the wind turbine 1.

The signal-processing unit 23 is configured to elaborate the entire set of position signals, part of the same, and possibly signals emitted by the pitch actuators 8, the inverter 11 and the speed sensor 12. In more detail, the signal-processing unit 23 is configured to run a plurality of programs each dedicated to the evaluation of an operational parameter on the bases of the at least some signals of the set of position signals and possibly additional signals acquired through the inverter 11 and/or the speed sensor 12.

The programs stored in the signal-processing unit include the following:
blade stress evaluation program;
blade fatigue evaluation program;
load calculation program;
ice detection program;
rotor unbalance detection program;
twist-bend coupling monitoring and control program;
Actuated aerodynamic surfaces monitoring and control program.

The blade stress evaluation program is indicated by block 30 in FIG. 6 and is aimed at evaluating whether each blade 7 is subject to stresses that can prejudice the integrity of the structure of the blade 7. Therefore, the position signals correlated to the deformation of each blade 7 are compared with threshold values in order to verify the occurrence of critical operational conditions for the blade 7. According to one embodiment, the deformations correspond to the displacement of the coordinates X, Y of one of the light reflectors 27 and 28 from a neutral position reference point. When one of the position signals X, Y exceeds a first threshold, the signal-processing unit 23 emits a control signal for controlling the pitch actuator 8 of the blade 7 in order to reduce the load on that blade 7. When one of the position signals X, Y exceeds a second threshold values, the signal-processing unit 23 emits a control signal for arresting the wind turbine 1, more precisely for actuating all pitch actuators 8, the brake actuator 10, and the inverter 11.

In other words, the blade stress evaluation program is cyclically run for each blade 7 and may turn into an adjustment of the pitch angles of the blades 7. The blade stress evaluation program is aimed at preserving the integrity of the blades 7 and avoiding excessive load on each blade 7.

The blade fatigue evaluation program is indicated by block 31 in FIG. 6 and is configured for processing the subset of position signals of each blade 7 through time in order to retrieve the oscillations of the blade 7 and determine frequencies and amplitudes of each oscillation. The information retrieved is compared with reference values in order to avoid critical oscillation frequencies. In cases the oscillation frequency falls within a critical range, the signal-processing unit 23 emits a control signal for controlling the pitch actuators 8 in order to modify the oscillation frequency. In particular the fatigue evaluation program is configured to calculate the fatigue loads of the blade during a certain period and to compare these loads with expected loads retrieved through calculations. Form the comparison of the measured data and the expected data, modification on the control system can be made.

The blade fatigue evaluation program 31 is run separately for each blade 7.

The load calculation program is indicated by block 32 in FIG. 6 and is configured to process the entire set of position signals of all blades 7, and comprises the step of calculating the overall deformation on the bases of the deviations from the neutral positions of the light reflectors 27 and 28 of all blades 7. The higher the overall deformation, the higher the load applied to the rotor 4. A comparison between the overall deformation and a reference threshold value may be implemented in order to run the wind turbine 1 below this reference threshold value. In this case, the signal-processing unit 23 emits control signals to actuate the pitch actuator 8 of all blades 7 in order to adjust the pitch angles for reducing the overall load.

The ice detection program is indicated by block 33 in FIG. 6 and is configured to compare the overall deformation of the blades 7, and the energy output by the rotating electric machine 5; and a reference system. The detection is based on the principle according to which ice on blades 7 changes the relationship between the load applied to the rotor and the natural frequencies in absence of ice. However, the load applied to the rotor is closely related to the energy output by the rotating electrical machine 5. Therefore, the ice detection program evaluates the oscillation frequencies of the blades 7 in relation to the energy output by the rotating electrical machine 5 and the spectrum of the natural frequencies of the blades 7. When the variations of the frequencies of oscillation of the blades 7 with respect to the natural frequencies of oscillation of the blades 7 at same load on rotor 4 is significant (exceeds a designated or given threshold), this variations can only be attributed to the different distribution of masses of the blades 7 caused by the icing formation along blades 7. When the ice detection program 33 detects a deformation lower than expected according to the above-identified parameters and with reference to the energy output, the signal-processing unit 23 emits a control signal for arresting the wind turbine 1 and/or start a de-icing program.

The rotor imbalance program is indicated by block 34 in FIG. 6 and is aimed at retrieving whether the rotational axis A of the rotor 4 is inclined with respect to its nominal position (as seen in FIG. 1). This anomalous operative condition may occur and can be detected and corrected. The rotor imbalance program 34 processes a subset of position signals in order to determine the oscillations (amplitudes and frequencies) of at least one blade 7 in relation to the rotational speed of the rotor 4. When the differences of oscillations (amplitudes and frequencies) though time exceed a designated or given range and the rotor 4 rotates at constant rotational speed, the signal-processing unit 23 is configured to send a control signal aimed at correcting the imbalance using the inverter 11 and/or the adjustment of the pitch angle of one or more blades 7.

The twist-bend coupling monitoring and control program is indicated by block 35 in FIG. 6 and is aimed at controlling the twist of the tip portion 16 of each blade 7. The twist-bend coupling monitoring and control program 35 compares the position signals associated to light reflector 27 and the position signal associated to light reflector 28 in order to identify the entity of the rotation of the tip portion 16 with respect to the intermediate portion 15. In case the retrieved twist does not fulfil the set operational conditions, the signal-processing unit 23 emits a control signal for controlling the pitch actuator 8 and adjusting the pitch angle of that blade 7. The twist-bend coupling monitoring and control program 35 is run for each blade 7.

In this way, a plurality of controls and adjustments of the wind turbine 1 can be carried out, in a relatively simple and reliable manner. The programs 30, 31, 32, 33, 34, 35 may advantageously include the significant process of comparing the static and dynamic deformations of each blade 7 with the static and dynamic deformations of the other blades 7.

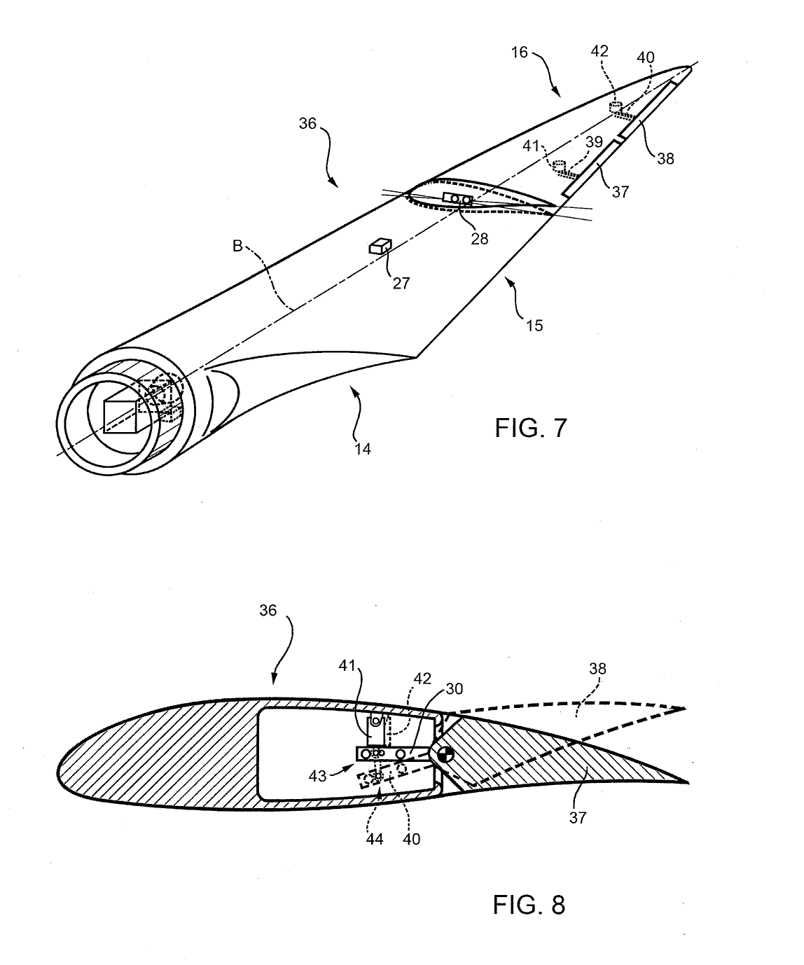

With reference to the embodiment shown in FIGS. 7 and 8, reference numeral 36 indicates a blade having a structure substantially similar to blade 7, wherein similar components are identified by the same reference numerals adopted with reference to blade 7. In fact, blade 36 is a variation of blade 7 wherein the tip portion 16 includes actuated aerodynamic surface such as flaps 37 and 38 that are located along the trailing edge of blade 36 and can be positively controlled.

In one embodiment, flaps 37 and 38 are pivotally connected to the tip portion 16, are provided with respective arms 39 and 40 extending inside blade 36, and actuated by respective flap actuators 41 and 42 located inside blade 36.

With reference to FIG. 7, the flaps 37 and 38 can be actuated in order to favour the twist of the tip portion 16 with respect to the intermediate portion 15. In one embodiment, as seen in FIG. 8, the image reflection measuring device 24 comprises, in addition to light reflectors 27 and 28, further light reflectors 43 and 44 respectively placed on arms 39 and 40 in order to determine a relationship between the position of flaps 37 and 38 and the twist effect on the tip portion 16. The light reflectors 43 and 44 allow a closed loop control of the position of the flaps 37 and 38 in order to improve the accuracy of the positioning of flaps 37 and 38.

In this embodiment, the signal-processing unit 23 (as seen in FIG. 6) is provided with a aerodynamic surface actuation and control program 45 in order to finely control the flaps 37 and 38 and monitoring the reaction on the twist of the tip portion 16 of the blade 36.

The present disclosure also extends to embodiments not described in the above detailed description, and to equivalent embodiments falling within the protective scope of the accompanying Claims. It should thus be understood that various changes and modifications to the presently disclosed embodiments will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A wind turbine comprising:
a rotor rotatable about a rotor axis, said rotor including:
a plurality of blades rotatably fitted to a hub about a blade axis, and
a plurality of pitch actuators, each pitch actuator configured to adjust a pitch angle of one of the blades;
a brake controlled by a brake actuator and configured to arrest the rotor;
a rotating electric machine directly connected to the rotor;
an inverter configured to control the rotating electric machine; and
a control system which:
includes a plurality of image reflection measuring devices configured to detect a designated deformation of each of the blades, and
is configured to emit at least one control signal to selectively control at least one of: the pitch actuators, the brake actuator, and the inverter, as a function of the designated deformation detected by the plurality of image reflection measuring devices.

2. The wind turbine of claim 1, wherein each image reflection measuring device is located inside one of the blades and includes:
a light source,
at least two light reflectors spaced apart along the blade axes and configured to reflect at least one light beam, and
a camera configured to receive the reflected at least one light beam and emit signals correlated to any retrieved images.

3. The wind turbine of claim 2, wherein the light reflectors are located at designated distances from the rotor axes and the light reflectors are distributed in each blade with the same spacing and the same distances from the rotor axis.

4. The wind turbine of claim 2, wherein each blade includes:
a root portion,
a intermediate portion including at least one of the light reflectors, and
a tip portion including at least one of the light reflectors, said tip portion having a structure configured to favour a twist of the tip portion with respect to the intermediate portion when the blade is loaded transversely to the blade axis.

5. The wind turbine of claim 4, wherein the blade is provided with at least one actuated surface pivotally connected to the blade and extending along a trailing edge of the tip portion.

6. The wind turbine of claim 5, wherein the at least one actuated surface includes at least one flap.

7. The wind turbine of claim 5, wherein the at least one actuated surface is associated with at least one of the light reflectors associated with controlling the position of the at least one actuated surface.

8. The wind turbine of claim 1, wherein the control system includes:
a plurality of image-processing units which emit a set of position signals correlated to a plurality of positions of a plurality of light reflectors in the blades; and
a signal-processing unit configured to run a plurality of programs to:
process one of: the set of position signals and at least one subset of the set of position signals, and
emit said at least one control signal.

9. A wind turbine blade configured to be rotatably fitted to a hub of a rotor about a blade axis, said rotor configured to rotate about a rotor axis and including at least one pitch actuator configured to adjust a wind turbine blade pitch angle, a brake controlled by a brake actuator and configured to arrest the rotor, a rotating electric machine directly connected to the rotor, an inverter configured to control the rotating electric machine and a control system, said wind turbine blade comprising:
an image reflection measuring device located inside a wind turbine blade body and configured to detect a designated wind turbine blade deformation, said image reflection measuring device including:
a light source, and
at least two light reflectors spaced apart along the blade axes and configured to reflect at least one light beam,
wherein said image reflection measuring device is configured to operate with said control system to emit at least one control signal to selectively control at least one of: the at least one pitch actuator, the brake actuator, and the inverter, as a function of the designated deformation detected by the image reflection measuring device.

10. The wind turbine blade of claim 9, wherein the image reflection measuring device includes a camera configured to receive the reflected at least one light beam.

11. The wind turbine blade of claim 9, wherein the light reflectors are located at designated distances from the rotor axes.

12. The wind turbine blade of claim 9, which includes:
a root portion,
a intermediate portion including at least one of the light reflectors, and
a tip portion including at least one of the light reflectors, said tip portion having a structure configured to favour a twist of the tip portion with respect to the intermediate portion when a load transverse to the blade axis is applied.

13. The wind turbine blade of claim 12, which includes at least one actuated surface pivotally connected and extending along a trailing edge of the tip portion.

14. The wind turbine blade of claim 13, wherein the at least one actuated surface includes at least one flap.

15. The wind turbine blade of claim 13, wherein the at least one actuated surface is associated with at least one of the light reflectors associated with controlling the position of the at least one actuated surface.

16. A method for controlling a wind turbine, wherein:
the wind turbine includes:
a rotor rotatable about a rotor axis and having a plurality of blades rotatably fitted to a hub about a blade axis and a plurality of pitch actuators, each pitch actuator configured to adjust a pitch angle of one of the blades,
a brake controlled by a brake actuator and configured to arrest the rotor,
a rotating electric machine connected to the rotor,
an inverter configured to control the rotating electric machine, and
a control system which includes a plurality of image reflection measuring devices configured to detect a designated deformation of each of the blades, and
the method comprising:
retrieving information from the plurality of image reflection measuring devices, said retrieved information associated with the designated deformation of any of the plurality of blades;
emitting at least one control signal correlated to the retrieved information; and
using the emitted at least one control signal to selectively control at least one of: the pitch actuators, the brake actuator, and the inverter.

17. The method of claim 16, which includes:
using a plurality of image-processing units to emit a set of position signals correlated to a position of at least two light reflectors located inside each of the plurality of blades, and
executing a plurality of programs to process one of: the set of position signals or at least one subset of the set of position signals, to calculate said at least one control signal and emit said at least one control signal.

18. The method of claim 17, which includes:
comparing the position signals correlated to the designated deformation of any of the blades to a plurality of threshold values, and
when one of the position signals exceeds the related threshold value, emitting the at least one control signal to at least one of: control the pitch actuator of at least one of the blades and arrest the rotor.

19. The method of claim 17, which includes:
processing at least of the subset of the set of position signals of each blade through time to retrieve any oscillations of the blade and determine frequencies and amplitudes of each oscillation,
comparing the determined oscillation frequencies with at least one reference value to avoid at least one critical oscillation frequency, and
when the determined oscillation frequencies falls within a critical range, emitting the at least one control signal to control the pitch actuator of at least one of the blades to modify the oscillation frequency of said blade.

20. The method of claim 17, which includes:
processing the set of position signals of each of the blades,
calculating an overall deformation of the rotor based on the deviations from at least one neutral position value of each of the blades,
comparing the overall deformation of the rotor and a reference threshold value, and
when the overall deformation of the rotor exceeds the reference threshold value, emitting the at least one control signal to actuate the pitch actuators of each of the blades.

21. The method of claim 17, which includes:
processing at least one of the subset of the set of position signals of at least one of the blades to calculate an oscillation frequency of the blade,
acquiring an energy output by the rotating electric machine,
comparing the calculated oscillation frequency at said energy output with a natural oscillation frequency at the same energy output in absence of ice, and
when the differences between the calculated frequency and the natural frequency exceed a designated threshold value, emitting the at least one control signal to, at least one of: arrest the rotor and start a de-icing program.

22. The method of claim 17, which includes:
processing at least one of the subset of the set of position signals to calculate any oscillations of at least one of the blades, and
when the differences of oscillations through time exceed a designated range and the rotor rotates at a constant rotational speed, emitting the at least one control signal to adjust at least one of: the inverter and the pitch angle of at least one of the blades.

23. The method of claim 17, wherein each blade includes:
a root portion,
an intermediate portion including at least one light reflector, and
a tip portion including at least one light reflector and having a structure configured to favour a twist of the tip portion with respect to the intermediate portion when the blade is loaded transversely to the blade axis, and
which includes:
comparing a plurality of the position signals associated with said light reflectors to calculate the twist of the tip portion with respect to the intermediate portion of one of the blades;
emitting the at least one control signal to control the pitch actuator of said blade, and
adjusting the pitch angle of said blade when the twist is outside a designated range.

24. The method of claim 17, wherein:
each of the blades is provided with at least one aerodynamic actuated surface pivotally connected to said blade and extending along a trailing edge of a tip portion of said blade, the aerodynamic actuated surface is connected to at least one light reflector, and
which includes acquiring the position of said aerodynamic actuated surface.

25. The method of claim 24, wherein the at least one aerodynamic actuated surface includes at least one flap.

26. The method of claim 17, which includes comparing the designated deformation of each of the blades with the designated deformation of the other blades.
